(19) United States
(12) Patent Application Publication
(10) Pub. No.: US 2016/0359312 A1
(43) Pub. Date: Dec. 8, 2016

(54) SURGE PROTECTOR HAVING BOTH FUSE AND ALERT FUNCTIONS

(71) Applicant: Tsan-Chi CHEN, New Taipei City (TW)

(72) Inventor: Tsan-Chi CHEN, New Taipei City (TW)

(21) Appl. No.: 14/848,427

(22) Filed: Sep. 9, 2015

(30) Foreign Application Priority Data
Jun. 5, 2015 (TW) 104118346

(51) Int. Cl. H02H 3/08

(52) U.S. Cl. CPC H02H 3/085

(57) ABSTRACT

The invention is to provide a surge protector having both fuse and alert functions, which comprises a dielectric material made of polycrystalline semiconductor ceramic material and having two electrodes respectively attached on two opposite sides thereof; two conductive bars made of a first electric conductive material and each having an end attached on one of the electrodes and other end defined as a first pin electrically connected to a power supply terminal of an electric device, wherein the first pin is divided into two sections, corresponding ends of the sections are welded by a second electric conductive material to connect in series, and the second electric conductive material has a melting point lower than that of the first electric conductive material; and an insulating element enclosing the dielectric material, electrodes and conductive bars except that the second electric conductive material and first pins are exposed out of the insulating element.

### FIELD OF THE INVENTION

The present invention generally relates to a surge protector, more particularly to a surge protector having both fuse and alert functions.

### BACKGROUND OF THE INVENTION

Currently, most electric devices are installed with switch control elements, such as relays, electronic switches or solenoids. During operation of the electric device, the switch control elements perform large amounts of switch actions to turn off or on circuits, so a lot of surges are occurred to negatively impact the operation of the electric device, such as false action of the electric device. To solve aforesaid problem, traditionally, the electric device provider installs a surge protector in a power supply terminal of the electric device, to generate a discharge path via the surge protector when the surge is occurred, thereby protecting the electric device from damage attributable to the surge.

Please refer to FIGS. 1 and 2 which respectively show a traditional surge protector 1 in market. The surge protector 1 includes a dielectric material 10, two conductive wires 12 and an insulating element 13. The dielectric material 10 is a plate made of the polycrystalline semiconductor ceramic material which contains a vast amount of disorderly zinc oxide grains, and the boundaries between the zinc oxide grains and the other oxides form boundary layers where diode effects occur, so that the entire dielectric material is equivalent to an aggregate of a large number of diodes connected back to back. When the dielectric material is subjected to a low voltage, only a small reverse leak current flow through the dielectric material, but when a high voltage is applied to the dielectric material, the punch-through effect occurs, causing the large current of the high voltage to pass through the dielectric material. The reason why the dielectric materials are extensively used in making surge protectors lies in their non-linear current-voltage characteristic curves, in which electrical resistance is high under a low voltage and low under a high voltage. Two electrodes 11 are attached on two opposite sides of the dielectric material 10, respectively. Each conductive wire 12 has an end fixed on the corresponding electrode 11 by welding, and other end defined as a pin 121 to electrically connect the traditional surge protector 1 to the power supply terminal of the electric device (not shown in Figs). The insulating element 13 encloses the dielectric material 10, the electrode 11 and the conductive wires 12, and only the pins 121 are exposed out of the insulating element 13.

In the traditional surge protector 1, the conductive wires 12 and the dielectric material 10 are connected via “line contact”, so the limited welding areas at fixed connection regions between the dielectric material 10 and the conductive wires 12 result in an extremely high voltage and current per unit area, which tends to cause breakage of the physical connections. Moreover, due to the extremely high voltage and current that the dielectric material 10 has to withstand per unit area, a strong transient overvoltage may pass through the dielectric materials 10 and form through holes in the resistors of the dielectric material 10 such that an even larger current runs through the resistors in an instant, causing high heat or fire by electric arc. In addition, research results show that the traditional surge protector 1 which has undergone the impact of large currents for many times tends to make aging of the dielectric material 10 prematurely because of high temperature even if no transient breakup or fire occurs, and premature aging of the dielectric material 10 will eventually lead to linearization of the low resistance range and formation of weak points on the dielectric material 10. Once the large leakage current is occurred more frequently and the leak current flows to the weak points in a concentrated manner, the weak points may melt and become short-circuit holes. When a large current gush into the short-circuit holes, high heat will be generated and consequently the traditional surge protector 1 may be fired. In view of the aforesaid shortcomings of the traditional surge protector 1, the manufacturer connects a fuse 3 with a power supply pin of a power supply terminal Vi of the electric device 2 in series when the traditional surge protector 1 is connected between the power supply terminal Vi and a circuit of the electric device 2 in parallel, so that a fuse element of the fuse 3 can be melted under the large current run therethrough in an instant and the occurred high temperature to form a cut-off state in a condition that the breakages are occurred at the fixed connection regions between the dielectric material 10 and the conductive wires 12, or the through holes are formed in the resistors of the dielectric material 10, thereby avoiding the fire occurred by continuous power supply and protecting the electric device from damage. However, the fuse 3 not only increases manufacturing cost and design complexity, but also occupies the space for circuits, and it is a main reason why the relevant circuit cannot be designed more compact.

Please refer to FIG. 4. Some manufacturers extra install a thermal fuse 14 in the traditional surge protector 1 shown in the FIGS. 1 and 2. An end 141 of the thermal fuse 14 is welded and fixed on the electrode 11. The thermal fuse 14, the dielectric material 10, the electrodes 11 and the conductive wires 12 are enclosed by the insulating element 13, and only the pins 121 and other end 142 of the thermal fuse 14 are exposed out of the insulating element 13, so that the thermal fuse 14 can be in cut-off state when sensing the temperature of the electrode 11 exceeding a predetermined threshold value, and then drive the power supply terminal to stop supplying power. However, the thermal fuse 14 increases not only the cost and volume of the surge protector, but also occupies more space for the circuit. In addition, an entire circuit of the electric device must be redesigned to timely stop supplying power according to the cut-off state of the thermal fuse 14, so the entire circuit becomes more complicated.

As described above, what is need is a surge protector having both fuse and alert functions by a simple structure and without extra cost, and the surge protector can not only discharge the surge, but also provide both fuse and alert functions without adding extra fuse and complicated alert circuit. Therefore, when the breakage is occurred at the fixed connection regions between the dielectric material 10 and the conductive wires 12 or the through holes are formed in the resistors of the dielectric material 10, the surge protector can be in cut-off state to avoid the danger attributable to the fire and protect the electric device from damage, and further alert a broken state thereof to the user for reminding the user to replace the broken surge protector as soon as possible.

### SUMMARY OF THE INVENTION

In view of the shortcomings of the traditional surge protector, the inventor develops a surge protector having both fuse and alert functions according to long-term experience in relevant industry and many designs and experiments, so as to improve the safety and alert effect of the surge protector and efficiently ensure the endurability and safety of the electric device.

An objective of the present invention is to provide a surge protector having both fuse and alert functions. The surge protector includes a dielectric material, two conductive bars (such as line-shaped or plate-shaped bar), and an insulating element. The dielectric material is a plate made of polycrystalline semiconductor ceramic material, and two electrodes are respectively attached on two opposite sides of the dielectric material. Each conductive bar is made of a first electric conductive material, and has an end attached on one of the two electrodes corresponding thereto and other end defined as a first pin. End portions of the first pins of the two conductive bars are electrically connected to a power supply terminal of an electric device, respectively. Each first pin is divided into two sections, and corresponding ends of the two sections are welded with a second electric conductive material to connect in series, and the second electric conductive material has a melting point lower than that of the first electric conductive material. When a large current flows through the conductive bar and the high temperature generated on the conductive bar exceeds the melting point of the second electric conductive material, the second electric conductive material is melted to make the corresponding ends of two sections of the first pin be cut off. The insulating element encloses the dielectric material, the electrodes and the two conductive bars, and only the second electric conductive material and the first pins are exposed out of the insulating element. Therefore, when a shock current of the surge flows through the surge protector, and the high voltage causes the breakages between the ends of conductive bars and the corresponding electrodes, or punches through the dielectric material, causing an extremely large current to run through the surge protector in an instant and an extremely high temperature, the second electric conductive material C will be melted rapidly under the extremely large transient current or the extremely high temperature to form the cut-off state of the first pin, so that a scheme equivalent to a fuse is generated to avoid the surge protector from being burnt by the large current continuously passed therethrough and the high temperature continuously accumulated, and the electric device and its electric circuit or elements can be protected from damage effectively.

Another objective of the present invention is that an end of each conductive bar is formed with a bent part which is attached with the corresponding electrode and enclosed in the insulating element. The bent part can increase the conductive contact area between the conductive bar and the corresponding electrode.

Another objective of the present invention is that each bent part is extended to form a second pin which is separated from the corresponding first pin, end portions of the second pins are connected in series via a light-emitting element, and the second pins and the light-emitting element are exposed out of the insulating element. Therefore, in a condition that the second electric conductive material is melted and the first pins are in cut-off state, the light-emitting element fails to receive power and stops lighting, so that the user can be alerted that the surge protector is broken, and should replace the broken surge protector by a new surge protector as soon as possible for ensuring that the subsequent shock current can be discharged by the new surge protector.

Another objective of the present invention is that the first electric conductive material has impedance smaller than that of the second electric conductive material, and when the large transient current runs through the second electric conductive material, the second electric conductive material will rapidly generate a high temperature and be melted under the high temperature because of its high impedance and low melting point, so that the first pin is rapidly in the cut-off state.

### BRIEF DESCRIPTION OF THE DRAWINGS

The detailed structure, operating principle and effects of the present invention will now be described in more details hereinafter with reference to the accompanying drawings that show various embodiments of the present invention as follows.

FIG. 1 is an exploded view of a traditional surge protector.

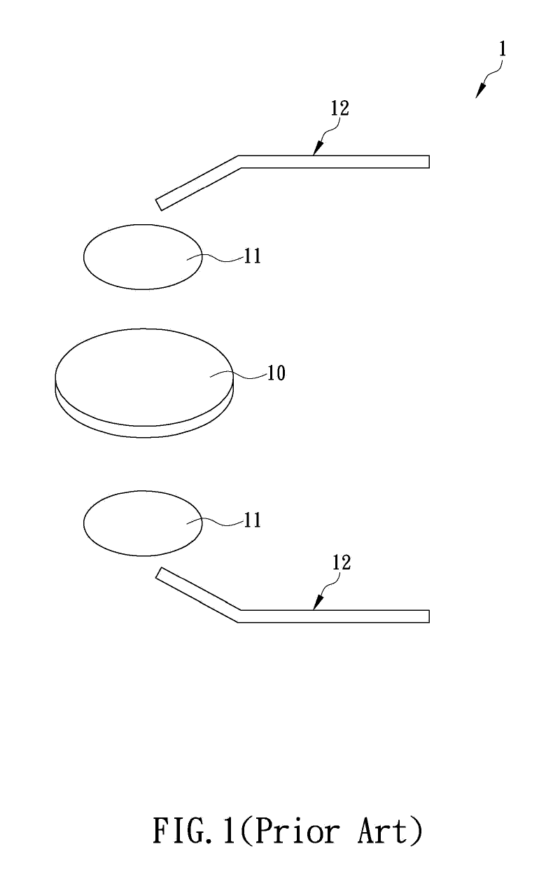

FIG. 2 is a cross-sectional view of a part of the traditional surge protector being assembled.

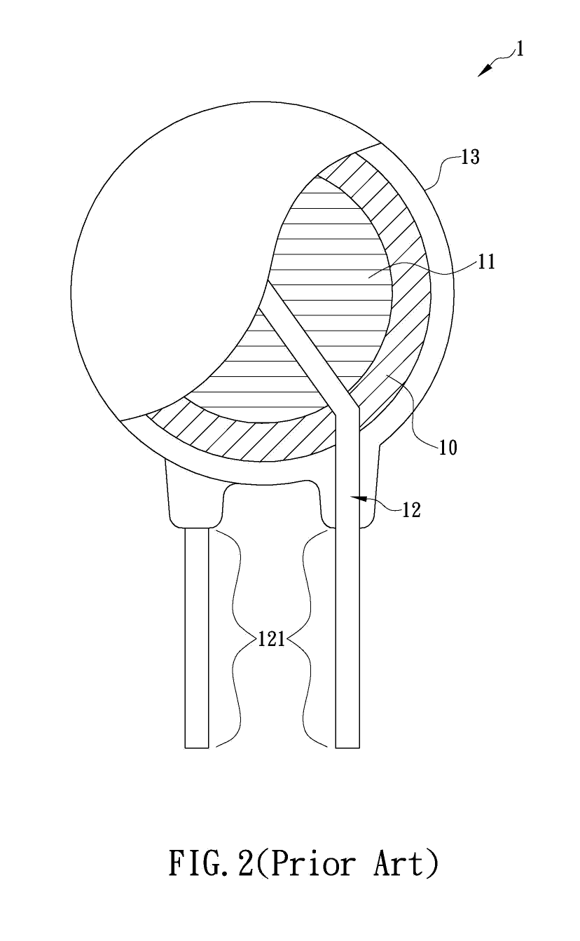

FIG. 3 is a schematic view of a circuit for installing the traditional surge protector.

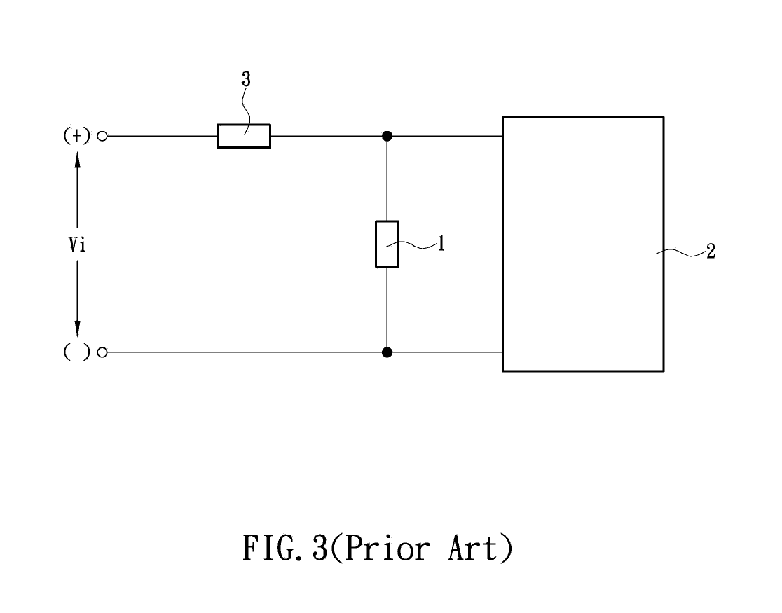

FIG. 4 is a cross-sectional view of a part of other traditional surge protector being assembled.

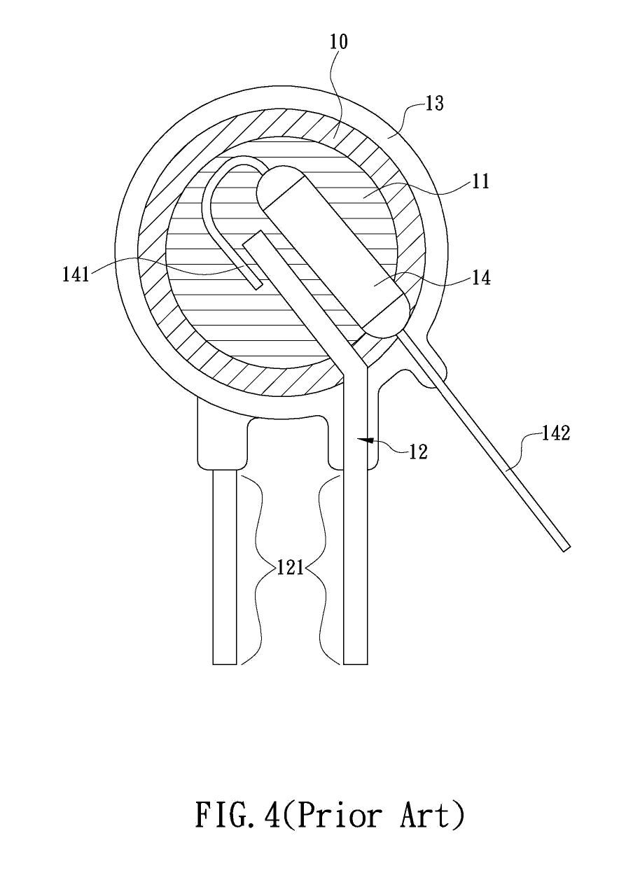

FIG. 5 is a cross-sectional view of a part of assembly of a first preferred embodiment of the present invention.

FIGS. 6(a), 6(b) and 6(c) shows schematic views of other structures for the conductive bar of the present invention.

FIG. 7 is a cross-sectional view of a part of a second preferred embodiment being assembled therein with the conductive bar shown in FIG. 6(a), in accordance with the present invention.

FIG. 8 is a cross-sectional view of a part of a third preferred embodiment being assembled therein with the conductive bar shown in FIG. 6(b), in accordance with the present invention.

FIG. 9 is a cross-sectional view of a part of a fourth preferred embodiment being assembled therein with the conductive bar shown in FIG. 6(c), in accordance with the present invention.

### DETAILED DESCRIPTION OF THE PREFERRED EMBODIMENTS

Reference will now be made in detail to the exemplary embodiments of the present invention, examples of which are illustrated in the accompanying drawings. Therefore, it is to be understood that the foregoing is illustrative of exemplary embodiments and is not to be construed as limited to the specific embodiments disclosed, and that modifications to the disclosed exemplary embodiments, as well as other exemplary embodiments, are intended to be included within the scope of the appended claims. These embodiments are provided so that this disclosure will be thorough and complete, and will fully convey the inventive concept to those skilled in the art. The relative proportions and ratios of elements in the drawings may be exaggerated or diminished in size for the sake of clarity and convenience in the drawings, and such arbitrary proportions are only illustrative and not limiting in any way. The same reference numbers are used in the drawings and the description to refer to the same or like parts.

It will be understood that, although the terms ‘first’, ‘second’, ‘third’, etc., may be used herein to describe various elements, these elements should not be limited by these terms. The terms are used only for the purpose of distinguishing one component from another component. Thus, a first element discussed below could be termed a second element without departing from the teachings of embodiments. As used herein, the term “or” includes any and all combinations of one or more of the associated listed items.

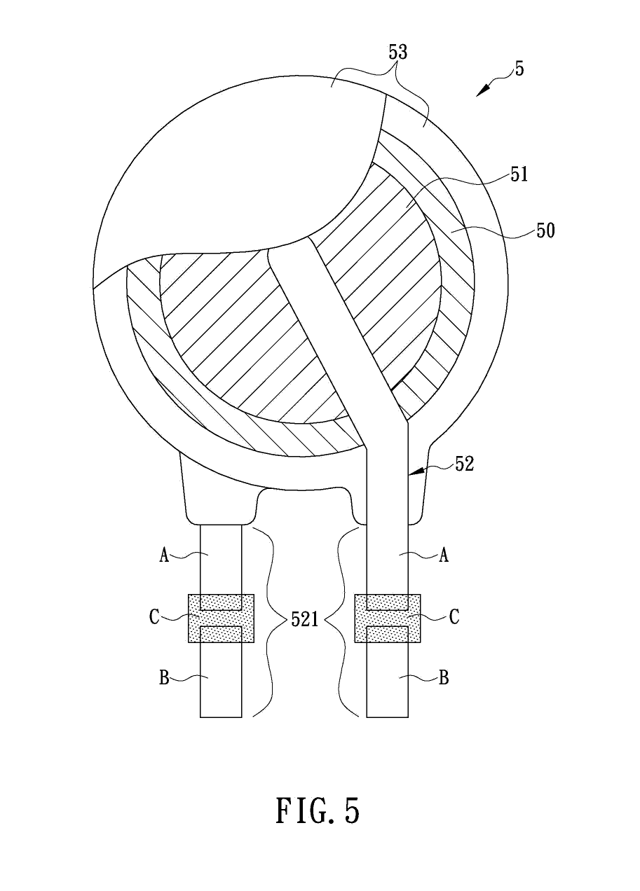

The present invention provides a surge protector having both fuse and alert functions. The surge protector can be applied to a power supply terminal of an electric device. Please refer to FIG. 5 which shows a first preferred embodiment of the present invention. The surge protector 5 includes a dielectric material 50, two conductive bars 52 and an insulating element 53. The dielectric material 50 is a plate made of a polycrystalline semiconductor ceramic material and two electrodes 51 are respectively attached on two opposite sides of the dielectric material 50. Each conductive bar 52 is made from a first electric conductive material, and has an end attached on the corresponding electrode 51 and other end defined as a first pin 521. End portions of the first pins 521 are electrically connected to the power supply terminal of the electric device (not shown in Fig), respectively. Each first pin 521 is divided into two sections A and B, and the corresponding ends of the sections A and B are welded by an electric conductive material C to connect integrally. The second electric conductive material C has a melting point lower than that of the first electric conductive material, so that the second electric conductive material C can be melted when the conductive bar 52 is passed a large current and generates a high temperature exceeding the melting point of the second electric conductive material, so as to cut off the corresponding ends of the two sections A and B of the first pin 521. The dielectric material 50, the electrode 51 and the ends of the conductive bars 52 are enclosed in the insulating element 53, and only the second electric conductive material C and the first pins 521 are exposed out of the insulating element 53. Therefore, when a shock current of the surge flows through the surge protector 5 and the high voltage causes the breakages between the ends of conductive bars and the corresponding electrodes 51, or punches through the dielectric material 50, the extremely large current is consequently generated to run through the surge protector 5 in an instant will and cause an extremely high temperature, and the second electric conductive material C will be melted rapidly by the extremely large transient current or extremely high temperature to form the cut-off state of the first pins 521, so that a scheme equivalent to the fuse is generated to avoid the surge protector 5 from being burnt by the large current continuously passed therethrough and the high temperature continuously accumulated, and the electric device and its electric circuit or elements can be protected from damage effectively.

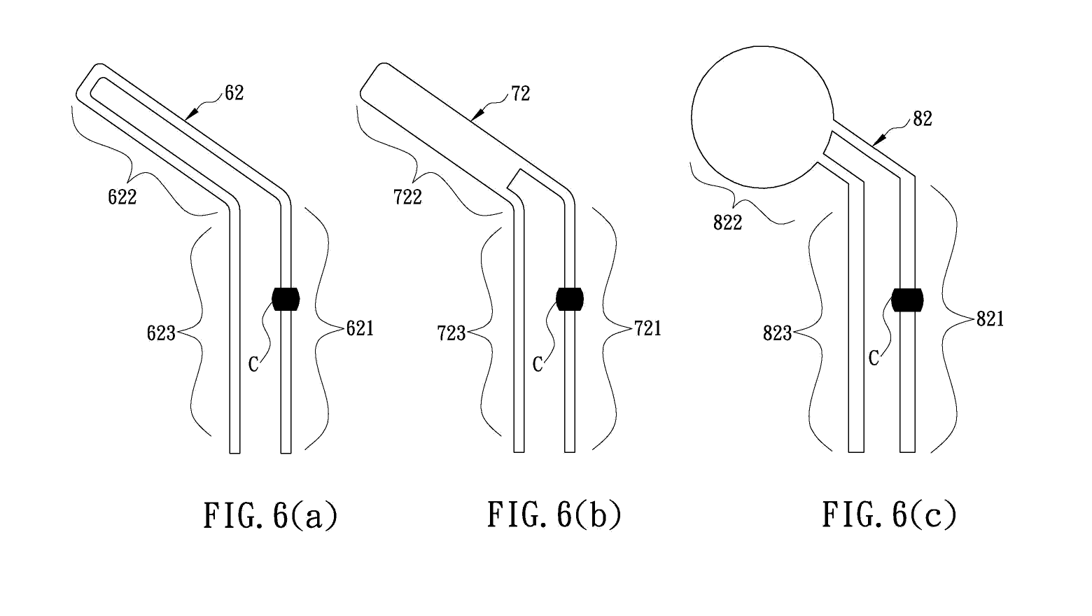

The structures of the conductive bars 52 of the present invention are not limited to that shown in the FIG. 5; alternatively, structures of the conductive bars 62, 72 and 82 shown in FIGS. 6(a), 6(b) and 6(c) can be applied to other embodiments of the present invention. Ends of the conductive bars 62, 72 and 82 are formed with bent parts 622, 722 and 822, respectively, and the bent parts 622, 722, 822 are attached on the corresponding electrodes 51 and enclosed in the insulating element 53, respectively. The conductive bar 62 is line-shaped and the bent part 622 is connected with the corresponding electrode 51 by line contact; the conductive bars 72 and 82 are plate-shaped, and the bent parts 722 and 822 are connected with the corresponding electrodes 51 by surface contact. Therefore, conductive contact area between the conductive bars 62, 72 and 82 and the corresponding electrodes 51 are increased.

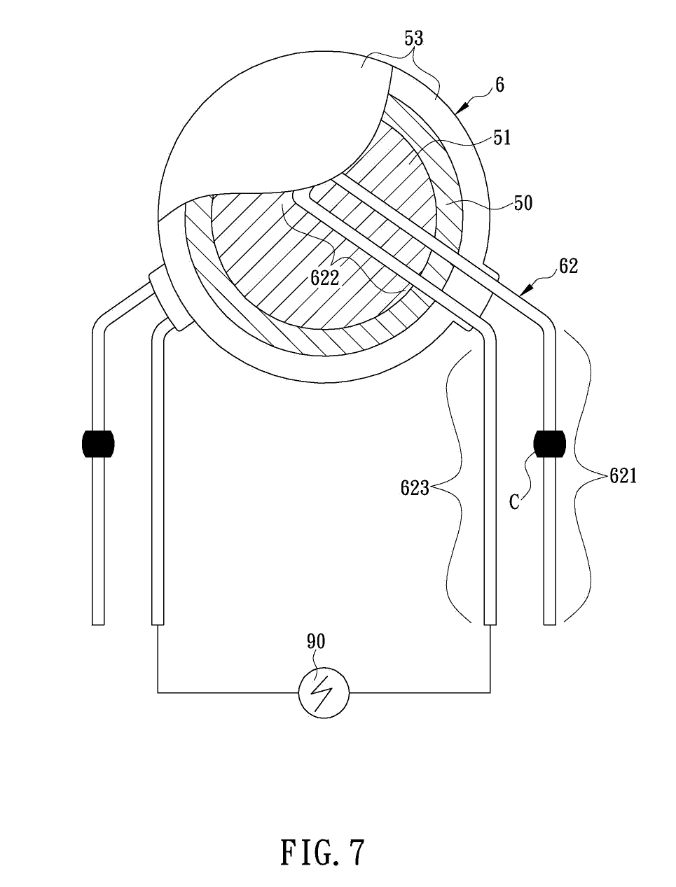

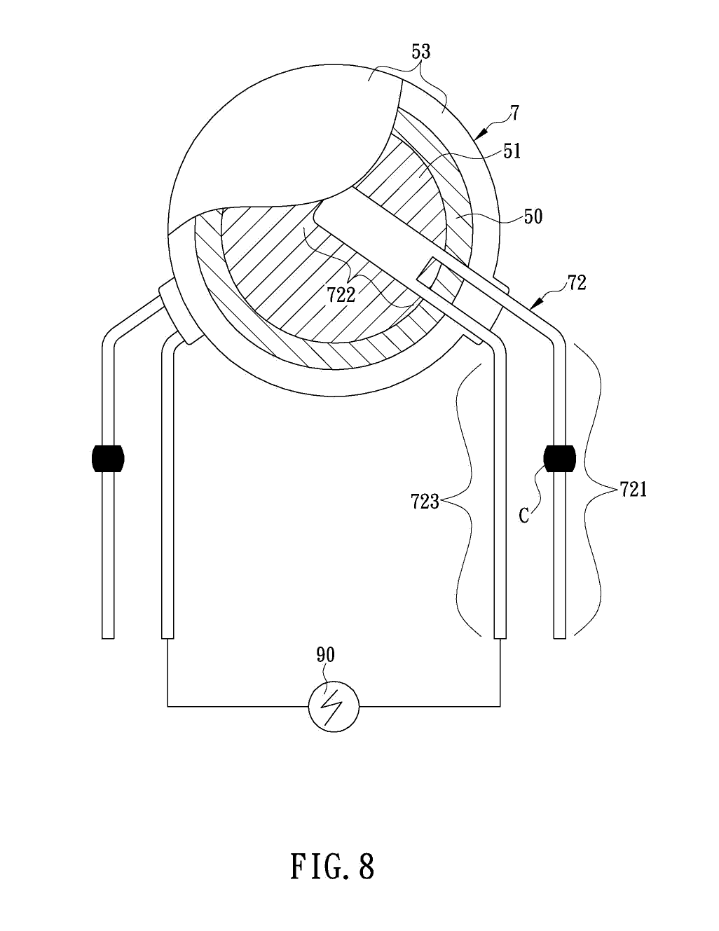

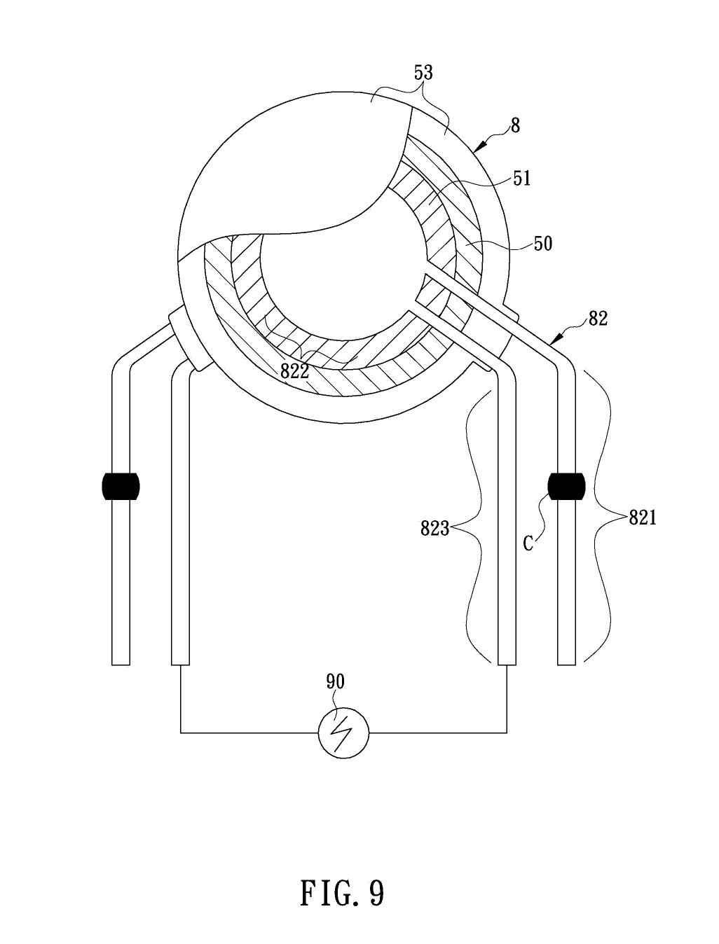

Please refer back to FIGS. 6(a), 6(b) and 6(c), in other embodiments of the present invention, apart from the first pins 621, 721 and 821, the conductive bars 62, 72 and 82 further have second pins 623, 723 and 823 extended from the bent parts 622, 722 and 822, respectively. The second pins 623, 723 and 823 are separated from the first pins, 621, 721 and 821 corresponding thereto, respectively. Please refer to FIGS. 7, 8 and 9. End portions of the second pins 623, 723 and 823 can be respectively connected in series via a light-emitting element 90 (such as LED), and the second pins 623, 723 and 823 and the light-emitting elements 90 are exposed out of the insulating element 53. Therefore, in a condition that the second electric conductive material C is melted and the first pins 621, 721 and 821 are in cut-off states, the light-emitting element 90 fails to receive power and consequently stops lighting, so that the user can be alerted breakages of the surge protectors 6, 7 and 8 and should replace the broken the surge protector by new surge protector as soon as possible, for ensuring that the subsequent shock current can be discharged by the new surge protector.

Please refer to the FIGS. 5, 7, 8 and 9. In the four preferred embodiments of the present invention, the first electric conductive materials of the conductive bars 52, 62, 72 and 82 have not only melting points larger than that of the second electric conductive material C, but also impedances smaller than that of the electric conductive material C. Preferably, the first electric conductive material can be copper, the second electric conductive material C can be aluminum, silver, tin, zinc or the alloy thereof. When the extremely large transient current runs through the second electric conductive material C, the second electric conductive material C can rapidly generate the high temperature and be melted under the high temperature because of its high impedance and the low melting point, and the first pins 521, 621, 721 and 821 can be rapidly in cut-off state.

Please refer back to FIGS. 7, 8 and 9. Without installing any additional fuse, the present invention can use the simple and low-cost structures of the aforesaid embodiments to completely perform mass production of the surge protectors 6, 7 and 8 having both fuse and alert functions. When the breakages are occurred at the fixed connection regions between the electrodes 51 and the conductive bars 62, 72 and 82, or the through holes are formed in the resistors of the dielectric material 50, the second electric conductive material C of the conductive bars 62, 72 and 82 can be melted under the high temperature caused by the large current run therethrough, so that the surge protectors 6, 7 and 8 can be in the cut-off states rapidly to avoid the danger attributable fire described in prior art, and protect the electric device from damage. In addition, the light-emitting element 90 can stop lighting to generate an alert signal to notice the user to replace the broken surge protectors by new surge protectors, to ensure the subsequent shock current to be discharged by the new surge protectors 6, 7 and 8.

The above-mentioned descriptions represent merely the exemplary embodiment of the present invention, without any intention to limit the scope of the present invention thereto. Various equivalent changes, alternations or modifications based on the claims of present invention are all consequently viewed as being embraced by the scope of the present invention.

What is claimed is:

1. A surge protector having both fuse and alert functions, comprising:
a dielectric material, being a plate made of polycrystalline semiconductor ceramic material and having two electrodes respectively attached on two opposite sides of the dielectric material;
two conductive bars, made of a first electric conductive material, and each of the two conductive bars having an end attached on one of the two electrodes corresponding thereto, and other end defined as a first pin, end portions of the first pins of the two conductive bars electrically connected to a power supply terminal of an electric device respectively, wherein each of the first pins is divided into two sections, corresponding ends of the two sections are welded by a second electric conductive material to connect in series, and the second electric conductive material has a melting point lower than that of the first electric conductive material; and
an insulating element, enclosing the dielectric material, the two electrodes and the two conductive bars, and only the second electric conductive material and the first pins exposed out of the insulating element.

2. The surge protector according to claim 1, wherein an end of each of the two conductive bars is formed with a bent part which is attached with one of the electrodes corresponding thereto and enclosed in the insulating element.

3. The surge protector according to claim 2, wherein each of the bent parts is extended to form a second pin which is separated from the first pin corresponding thereto, end portions of the second pins are connected in series via a light-emitting element, and the second pins and the light-emitting element are exposed out of the insulating element.

4. The surge protector according to one of claim 1, wherein the first electric conductive material has impedance smaller than that of the second electric conductive material.

5. The surge protector according to one of claim 2, wherein the first electric conductive material has impedance smaller than that of the second electric conductive material.

6. The surge protector according to one of claim 3, wherein the first electric conductive material has impedance smaller than that of the second electric conductive material.

7. The surge protector according to claim 4, wherein the first electric conductive material is copper, and the second electric conductive material is aluminum, silver, tin, zinc, or the alloy thereof.

8. The surge protector according to claim 5, wherein the first electric conductive material is copper, and the second electric conductive material is aluminum, silver, tin, zinc, or the alloy thereof.

9. The surge protector according to claim 6, wherein the first electric conductive material is copper, and the second electric conductive material is aluminum, silver, tin, zinc, or the alloy thereof.

10. The surge protector according to claim 7, wherein the conductive bar is line-shaped, and each of the bent parts is connected to the electrode corresponding there to by line contact.

11. The surge protector according to claim 8, wherein the conductive bar is line-shaped, and each of the bent parts is connected to the electrode corresponding there to by line contact.

12. The surge protector according to claim 9, wherein the conductive bar is line-shaped, and each of the bent parts is connected to the electrode corresponding there to by line contact.

13. The surge protector according to claim 7, wherein the conductive bar is plate-shaped, and each of the bent parts is connected to the electrode corresponding thereto by surface contact.

14. The surge protector according to claim 8, wherein the conductive bar is plate-shaped, and each of the bent parts is connected to the electrode corresponding thereto by surface contact.

15. The surge protector according to claim 9, wherein the conductive bar is plate-shaped, and each of the bent parts is connected to the electrode corresponding thereto by surface contact.
